(19) United States
(12) Patent Application Publication
(10) Pub. No.: US 2008/0120307 A1
(43) Pub. Date: May 22, 2008

(54) GUIDED CLUSTER ATTRIBUTE SELECTION

(75) Inventors: Glen Anthony Ames, Mountain View, CA (US); David A. Burgess, Menlo Park, CA (US); Joshua Ethan Miller Koran, Mountain View, CA (US); Amit Umesh Shanbhag, San Francisco, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/561,779

(22) Filed: Nov. 20, 2006

(51) Int. Cl. G06F 17/30

(52) U.S. Cl. 707/100; 707/E17.046

(57) ABSTRACT

A method for selecting at least one target customer attribute from a plurality of customer attributes, wherein each customer attribute represents a unique customer characteristic is provided. The plurality of customer attributes is presented for selection. A selection of at least one target customer attribute selected from the plurality of customer attributes is received. For each cluster of a plurality of clusters, indicated the statistic of customers belonging to that cluster who possess each and every one of the at least one target customer attribute. The plurality of clusters comprises a plurality of customers and each customer of the plurality of customers belongs to at least one cluster of the plurality of clusters.

### BACKGROUND

Marketing is the art of reaching the right people with the right messages at the right time. Since marketers generally cannot afford to craft unique messages for each individual target customer, they deal with large segments of each of their target markets at a time. Clustering is often used to help the marketers determine the desirable segments of customers for target marketing. While clustering can assign each individual customer to a specific cluster, it is useful for the marketers to find a set of customer attributes that uniquely identify one particular cluster of individuals from the other clusters of individuals, so that the marketers can use these customer attributes to target other individuals who also satisfy or possess these customer attributes. These attributes can also be used to identify good candidates for a particular goal (e.g., product purchase) among people who have not yet done the activity that measures the success of the marketer's goal.

It is particularly useful for marketers to select the correct set of customer attributes for each target advertisement, such that these selected customer attributes identify those customer characteristics that are particularly desirable to the marketers in a specific segment of their target audience and improve the coverage of the target audience while reducing the number of people not in this segment of their target audience. Furthermore, there is often a cost associated with each customer attribute, when using that attribute for targeting. Usually, the more customer attributes used by the marketers to identify their target audience, the higher the cost. Thus, marketers often make the choice of selecting fewer customer attributes in order to maximize target coverage while at the same time keeping the cost of advertisement reasonable.

In addition to selecting the attributes that increase the coverage of their target audience, marketers also desire to increase the coverage of high value customers. If the high value customers are previously defined, then the marketer can choose the sets of attributes that increase the total coverage of these high value customers, while reducing the coverage of non-high value customers.

### SUMMARY

A method is provided for selecting at least one target customer attribute from a plurality of customer attributes, wherein each customer attribute represents a unique customer characteristic. The plurality of customer attributes for selection is presented for selection. At least one target customer attribute is selected from the plurality of customer attributes. For each cluster of a plurality of clusters, wherein the plurality of clusters comprises a plurality of customers and each customer of the plurality of customers belongs to at least one cluster of the plurality of clusters, at least one statistic relative to customers belonging to that cluster who possess each and every one of the at least one target customer attribute is indicated.

More specifically, each target customer attribute increases the coverage of a target segment of prospects, while reducing the coverage of non-target segments. As a user selects each customer attribute, the coverage statistic is updated for each of the plurality of clusters. By previously scoring some records as higher value than others (e.g., by profitability), the coverage statistic of these higher value records may also be updated. In one example, the plurality of clusters comprises a plurality of customers and each customer of the plurality of customers belongs to at least one cluster of the plurality of clusters. In another example, each record may belong to more than one cluster. This method of display is not limited to analyzing customer records, but may also apply to analyzing attributes of advertisements, attributes of products and attributes of media or other content or data.

In yet another example, a cost is associated with each customer attribute of the plurality of customer attributes. At least one target customer attribute is selected from the plurality of customer attributes, such that the sum of the cost of the at least one selected target customer attributes is dynamically updated and the at least one selected target customer attribute improves the number of customers belonging to the plurality of clusters who possess each and every one of the at least one target customer attribute.

In yet another example, a value is associated with each customer and a cost is specified for targeting. At least one target customer attribute is selected from the plurality of customer attributes, such that the return on targeting at least one selected target customer attributes is greater than or equal or close to the specified return and at least one selected target customer attribute determines the number of customers belonging to the plurality of clusters who possess each and every one of the at least one target customer attribute.

These and other features will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a high level flowchart of a method for selecting at least one target customer attribute from a plurality of customer attributes.

FIG. 2 shows an example of a display in tabular format representing multiple customer attributes for selection and multiple clusters that comprises customers.

FIG. 3 is a flowchart of a method for dynamically updating the cost of using combinations of selected target customer attributes.

### DETAILED DESCRIPTION

As described in the background, it is useful to segment customers into clusters for target advertisements. In order to determine an appropriate set of customer attributes, where each customer attribute represents a desirable unique characteristic of the target customers, for target marketing purposes, marketers often segment the customers into multiple clusters first, and then choose a subset of these clusters that includes those customers that satisfy or possess one or more desirable customer attributes for the marketers' specific requirements. For example, the customers may be segmented into different clusters based on the characteristics of the customers, such as segmenting customers according to their respective age, and/or according to their respective residential location, and/or according to their respective hobby interest. Alternatively, customers may be segmented according to other types of criteria. One way of segmenting customers into different clusters is described in U.S. patent application Ser. No. 11/550,709 (Attorney Docket Number YAH1P019).

Regardless of how the customers are segmented into different clusters, the purpose of this invention is to aid a user in choosing the ideal set of attributes that improves the coverage of their target records, while reducing the coverage of non-target records. This selection process can be further aided by exposing the cost of the selected attributes. Records belong to the same cluster usually share some similar characteristics, and each record belongs to at least one cluster. For marketing purposes, these records most often consist of customers or prospects.

A customer attribute represents a unique characteristic of the customers, and there may be multiple customer attributes representing multiple characteristics. Because customers are segmented into one of a multitude of clusters based on their characteristics, sets of customer attributes may be used to differentiate each individual cluster from all other clusters. For example, a customer attribute that represents the age of the customers may be used to differentiate the customers into different age groups, such as children versus adults, or young adults versus middle-aged people. A customer attribute that represents the geographical location of the customers may be used to differentiate the customers into different geographical groups. A customer attribute that represents the gender of the customers may be used to differentiate the customers into three groups of male, female, and unknown. A customer attribute that represents the hobby interest of the customers may be used to differentiate the customers into different special interest groups, such as sport versus art versus literature.

Marketers select one or more customer attributes, and each selected customer attribute identifies or represents a unique and desirable characteristic of their desired target audience. The combination of selected target customer attributes are then used to identify a given target audience. Guidance is provided to the marketers in their effort to select the correct set of target customer attributes in terms of which customer attributes provide the marketers a higher coverage of the target customers, a low coverage of non-target customers, and what costs are associated with different sets of selected target customer attributes.

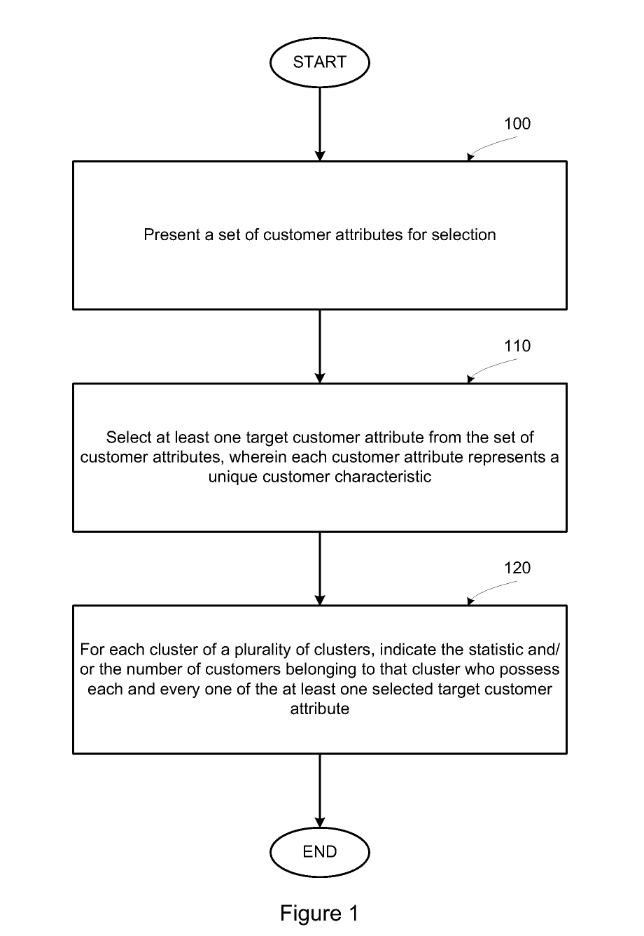

FIG. 1 is a high level flowchart of a method for selecting at least one target customer attribute from a plurality of customer attributes. Referring to FIG. 1, after the customers are segmented into multiple clusters, typically based on their respective characteristics, where each customer belongs to at least one cluster, a set of customer attributes is presented for selection, to be selected by a marketer STEP 100. As described above, each customer attribute describes or represents a unique characteristic of the customers. The selected set of customer attributes will denote the relevant characteristics that define a given target segment, which may be a subset of one or more clusters.

The marketer selects, from the set of customer attributes, one or more target customer attributes, such that each selected target customer attribute defines a unique characteristic that may be desirable of the target customers STEP 110. In other words, the marketer would select those customer attributes that increase the coverage of the target audience. For example, assume a marketer is seeking a target audience that will increase the sales of female outdoor active clothing. By examining the past purchase activity, he or she may identify that females, between 20 and 50 years of age, who have an interest in hiking are the characteristics that best define the target audience for increasing the sales of female outdoor active clothing. To determine these characteristics, the marketer noticed that when selecting the gender customer attribute to be female, the age customer attribute to be between 20 and 50 years old, with a hobby interest in outdoor activities such as hiking, the coverage of customers who had purchased female outdoor active clothing was higher than other combinations of customer attributes and had a lower coverage of non-purchasers of female outdoor active clothing. Thus, the selected target customer attributes define the desirable characteristics of the target customers.

Once a set of target customer attributes is selected, for each cluster of the plurality of clusters, the statistic and/or the number of customers belonging to that cluster who possess each and every one of the selected target customer attributes is indicated STEP 120. This information may indicate to the marketer the coverage of the target audience for the selected set of target customer attributes. Coverage is the ratio of customers who possess the all of the selected target customer attributes to the total number of customers being analyzed. For example, if 80% of the customers in a given cluster are male, then selecting a single gender customer attribute to be male gives 80% coverage of that cluster. The coverage statistic is independently calculated per cluster. By selecting the male customer attribute, the coverage of each cluster is updated. Since the clusters contain a heterogeneous distribution of attributes, selecting more attributes tends to increase the difference in the coverage of each cluster.

If the marketer is not satisfied with the statistic and/or the target audience coverage given by the set of target customer attributes he or she has selected, he or she may select a different set of target customer attributes, and accordingly, a different target audience coverage is indicated for each cluster of the plurality of clusters. In other words, the statistic and/or the target audience coverage for each cluster of the plurality of clusters are dynamically updated as the marketer selects different sets of target customer attributes, and the updated statistic and/or target audience coverage is shown to the marketer. Thus, as soon as the marketer selects a new set of target customer attributes, he or she is able to see the effect of that selection in terms of how well a target audience coverage that set of selected target customer attributes provides. The marketer may then make a decision accordingly as to whether that particular set of selected target customer attributes is satisfactory with respect to providing and improving sufficient target audience coverage. If so, the marketer may decide to use that set of selected target customer attributes for advertisement. If not, the marketer may select another different set of target customer attributes to further improve the statistic and/or target audience coverage until the marketer is completed satisfied.

The marketer may repeat the process until he or she is satisfied with the target audience coverage given by a particular set of selected target customer attributes. By allowing the marketer to see the different target audience coverage, and associated costs and values, as he or she selects different sets of target customer attributes, the marketer is guided to selected the ideal number of customer attributes and select only those customer attributes that give the best target audience coverage. Additional guidance information provided to the marketer include indicating which set of customer attributes best distinguish a particular cluster from all other clusters, and which customer attribute is most heavily represented within any given cluster.

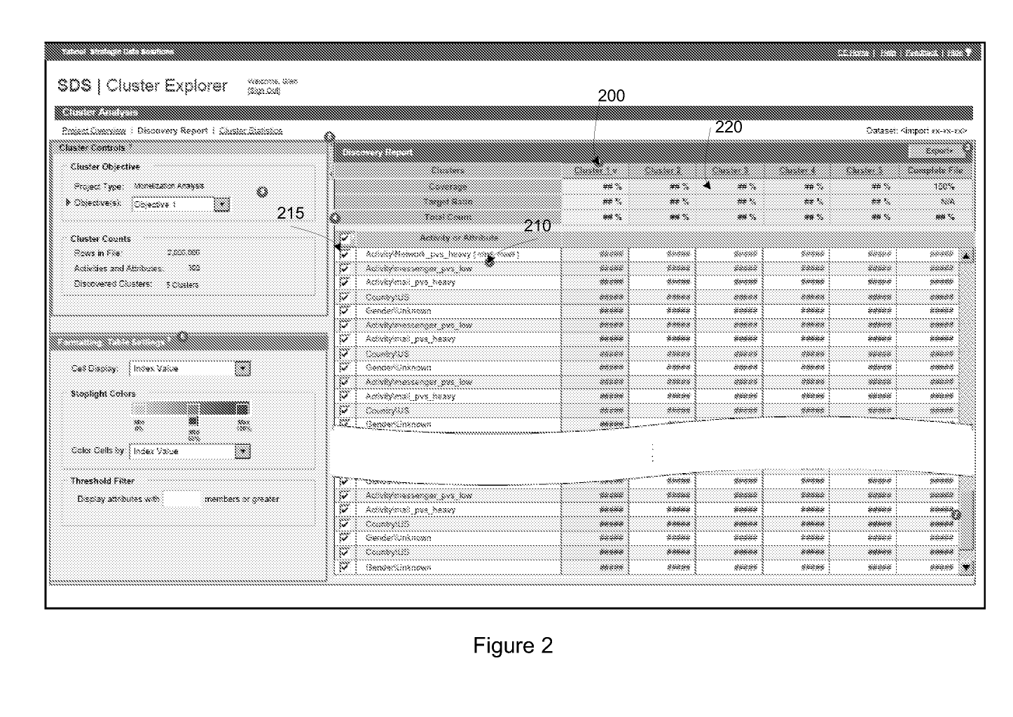

To further illustrate the process of customer attributes selection, FIG. 2 shows an example of a display in tabular format representing multiple customer attributes for selection and multiple clusters that comprises customers. In this example, the customers are segmented into five clusters. The columns 200 represent the five clusters. The rows 210 represent the customer attributes, listed in alphabetical order. A checkbox 215 is associated with each customer attribute for selection. The marketer my select any customer attribute 210 by checking the checkbox 215 next to that customer attribute 210. Conversely, the marketer may deselect any customer attribute 210 by unchecking the checkbox 215 next to that customer attribute 210. The marketer may select any number of customer attributes, from 1 customer attribute to the total number of customer attributes available.

Once the marketer selects a set of target customer attributes, the target audience coverage is indicated in the table cells 220 for each cluster. That is, for each cluster, the marketer is shown, for example, the percentage of customers in that cluster who possess the selected target customer attributes. This information is updated dynamically as the marketer selects or deselects different customer attributes 210 by checking or un-checking the checkboxes 215 next to those attributes 210. In another example, the statistics are updated in batch once the marketer has made all their selections and communicates this by the interaction with a user interface element, such as a button. Similarly, the marketer may also be shown other statistics, such as the actual number of customers in each cluster who possess the selected target customer attributes.

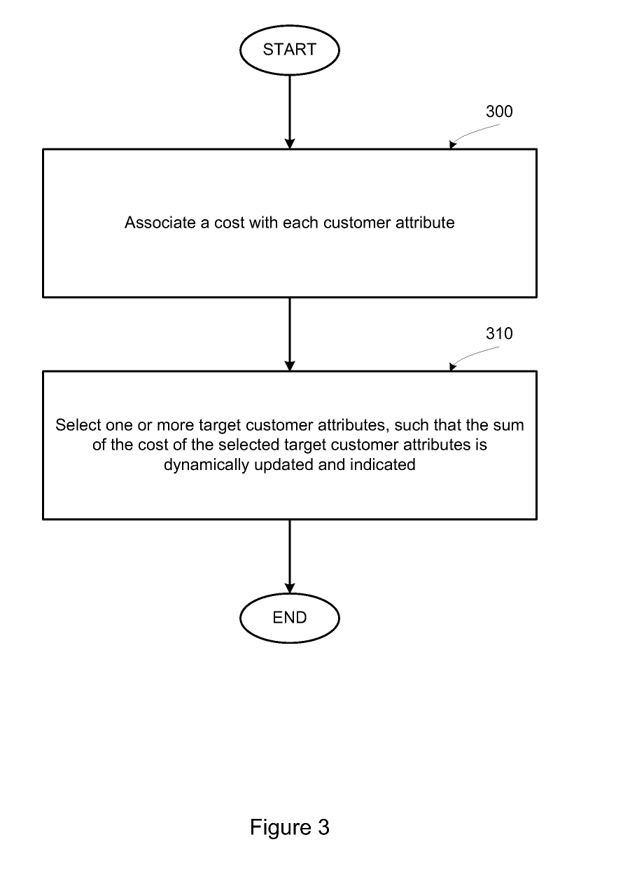

FIG. 3 is a flowchart of a method for dynamically updating the cost of using combinations of selected target customer attributes. A cost is associated with each customer attribute STEP 300. Different customer attributes may cost different amounts of money. Usually, this cost reflects the cost of advertisement of a customer attribute if a marketer selects that customer attribute as one of the desirable characteristics for his or her target audience.

Instead of selecting each target customer attribute solely in relation to the statistics described in FIG. 1, the marketer may also use the cost of these attributes in making the tradeoff decisions. At STEP 310, as the marketer selects one or more target customer attributes, the sum of the cost of the selected target customer attributes is dynamically updated and the updated cost sum is indicated to the marketer. In other words, as the marketer selects different sets of target customer attributes, the sum of the cost of the selected target customer attributes is dynamically updated to further help the marketer in making his or her decision in terms of whether the selected target customer attributes costs too much. Thus, the cost of the selected customer attributes may also limit the combinations of customer attributes the marketer wishes to select.

The methods described above may be carried out, for example, in a programmed computing system.

The methods described above have various advantages over the prior art. For example, by showing the marketer the target audience coverage for a set of selected target customer attributes, the marketer may adjust the customer attribute selection to obtain the best target audience coverage. The marketer may also easily understand the tradeoff between using fewer target customer attributes and the accuracy of the coverage for each cluster.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A method for selecting at least one target customer attribute from a plurality of customer attributes, wherein each customer attribute represents a unique customer characteristic, comprising:
presenting the plurality of customer attributes for selection;
receiving a selection of the at least one target customer attribute from the plurality of customer attributes; and
for each cluster of a plurality of clusters, wherein the plurality of clusters comprises a plurality of customers and each customer of the plurality of customers belongs to at least one cluster of the plurality of clusters, indicating at least one statistic relative to customers belonging to that cluster who possess each and every one of the at least one target customer attribute.

2. The method, as recited in claim 1, wherein the at least one statistic for each cluster of the plurality of clusters includes an indication of the percentage of customers belonging that cluster who possess each and every one of the at least one target customer attribute.

3. The method, as recited in claim 1, wherein the at least one statistic for each cluster of the plurality of clusters includes an indication of the number of customers belonging that cluster who possess each and every one of the at least one target customer attribute.

4. The method, as recited in claim 1, wherein the at least one statistic for each cluster of the plurality of clusters is at least one selected from the group consisting
an indication of the percentage of customers belonging to that cluster who possesses each customer attribute of the plurality of customer attributes,
an indication of the number of customers belonging to that cluster who possesses each customer attribute of the plurality of customer attributes, and
an indication of the success-measure characteristic of customers belonging to that cluster who possesses each customer attribute of the plurality of customer attributes.

5. The method, as recited in claim 4, wherein the success-measure characteristic is at least one selected from the group consisting cost, value, and return.

6. The method, as recited in claim 1, further comprising:
determining a cluster of the plurality of clusters based on the at least one statistic; and
indicating the determined cluster.

7. The method, as recited in claim 6, wherein determining a cluster of the plurality of clusters based on the at least one statistic includes determining a cluster of the plurality of clusters that improves the percentage of customers who possess each and every one of the at least one target customer attribute than all other clusters of the plurality of clusters.

8. The method, as recited in claim 6, wherein determining a cluster of the plurality of clusters based on the at least one statistic includes determining a cluster of the plurality of clusters that improves the number of customers who possess each and every one of the at least one target customer attribute than all other clusters of the plurality of clusters.

9. The method, as recited in claim 1, further comprising:
selecting the at least one target customer attribute from the plurality of customer attributes, such that the selected at least one target customer attribute improves the number of customers belonging to a cluster of the plurality of clusters who possess each and every one of that at least one target customer attribute and reduces all other clusters of the plurality of clusters.

10. The method, as recited in claim 1, further comprising:
for each cluster of the plurality of clusters, selecting the at least one target customer attribute from the plurality of customer attributes, such that the at least one target customer attribute improves the number of customers belonging to that cluster of the plurality of clusters who possess each and every one of that at least one target customer attribute and reduces all other clusters of the plurality of clusters.

11. The method, as recited in claim 1, further comprising:
for each cluster of the plurality of clusters, indicating a customer attribute of the plurality of customer attributes that is possessed by the most number of customers belonging to that cluster.

12. The method, as recited in claim 1, further comprising:
for each cluster of the plurality of clusters, indicating a customer attribute of the plurality of customer attributes that improves the percentage of customers belonging to that cluster for the least cost.

13. The method, as recited in claim 1, further comprising:
for each cluster of the plurality of clusters, indicating a customer attribute of the plurality of customer attributes that is possessed by the most number of customers belonging to that cluster for the least cost.

14. The method, as recited in claim 1, further comprising:
selecting a plurality of potential customers based on the selection of the at least one target customer attribute; and
providing target advertisement to the plurality of potential customers.

15. A computer system configured to execute the method of claim 1.

16. A computer program product for selecting at least one target customer attribute from a plurality of customer attributes, wherein each customer attribute represents a unique customer characteristic, the computer program product comprising at least one computer-readable medium having computer program instructions stored therein which are operable to cause at least one computer device to:
present the plurality of customer attributes for selection;
receive a selection of the at least one target customer attribute from the plurality of customer attributes; and
for each cluster of a plurality of clusters, wherein the plurality of clusters comprises a plurality of customers and each customer of the plurality of customers belongs to at least one cluster of the plurality of clusters, indicate at least one statistic relative to customers belonging to that cluster who possess each and every one of the at least one target customer attribute.

17. The computer program product, as recited in claim 16, wherein the at least one statistic for each cluster of the plurality of clusters includes an indication of the percentage of customers belonging that cluster who possess each and every one of the at least one target customer attribute.

18. The computer program product, as recited in claim 16, wherein the at least one statistic for each cluster of the plurality of clusters includes an indication of the number of customers belonging that cluster who possess each and every one of the at least one target customer attribute.

19. The computer program product, as recited in claim 16, wherein the at least one statistic for each cluster of the plurality of clusters is at least one selected from the group consisting
an indication of the percentage of customers belonging to that cluster who possesses each customer attribute of the plurality of customer attributes,
an indication of the number of customers belonging to that cluster who possesses each customer attribute of the plurality of customer attributes, and
an indication of the success-measure characteristic of customers belonging to that cluster who possesses each customer attribute of the plurality of customer attributes.

20. The computer program product, as recited in claim 19, wherein the success-measure characteristic is at least one selected from the group consisting cost, value, and return.

21. The computer program product, as recited in claim 16, further comprising computer program instructions to:
determine a cluster of the plurality of clusters based on the at least one statistic; and
indicate the determined cluster.

22. The computer program product, as recited in claim 21, wherein determining a cluster of the plurality of clusters based on the at least one statistic includes determining a cluster of the plurality of clusters that improves the percentage of customers who possess each and every one of the at least one target customer attribute than all other clusters of the plurality of clusters.

23. The computer program product, as recited in claim 21, wherein determining a cluster of the plurality of clusters based on the at least one statistic includes determining a cluster of the plurality of clusters that improves the number of customers who possess each and every one of the at least one target customer attribute than all other clusters of the plurality of clusters.

24. The computer program product, as recited in claim 16, further comprising computer program instructions to:
select the at least one target customer attribute from the plurality of customer attributes, such that the selected at least one target customer attribute improves the number of customers belonging to a cluster of the plurality of clusters who possess each and every one of that at least one target customer attribute and reduces all other clusters of the plurality of clusters.

25. The computer program product, as recited in claim 16, further comprising computer program instructions to:
for each cluster of the plurality of clusters, select the at least one target customer attribute from the plurality of customer attributes, such that the at least one target customer attribute improves the number of customers belonging to that cluster of the plurality of clusters who possess each and every one of that at least one target customer attribute and reduces all other clusters of the plurality of clusters.

26. The computer program product, as recited in claim 16, further comprising computer program instructions to:
for each cluster of the plurality of clusters, indicate a customer attribute of the plurality of customer attributes that is possessed by the most number of customers belonging to that cluster.

27. The computer program product, as recited in claim 16, further comprising computer program instructions to:
for each cluster of the plurality of clusters, indicate a customer attribute of the plurality of customer attributes that improves the percentage of customers belonging to that cluster for the least cost.

28. The computer program product, as recited in claim 16, further comprising computer program instructions to:
for each cluster of the plurality of clusters, indicate a customer attribute of the plurality of customer attributes that is possessed by the most number of customers belonging to that cluster for the least cost.

29. The computer program product, as recited in claim 16, further comprising computer program instructions to:
select a plurality of potential customers based on the selection of the at least one target customer attribute; and
provide target advertisement to the plurality of potential customers.
